(19) United States
(12) Patent Application Publication
(10) Pub. No.: US 2010/0213646 A1
(43) Pub. Date: Aug. 26, 2010

(54) METHOD FOR PRODUCING METAL COMPLEX OXIDE SINTERED BODY

(75) Inventor: Koh TAKAHASHI, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: UNIVERSAL ENTERTAINMENT, Koto-ku (JP)

(21) Appl. No.: 12/677,557

(22) PCT Filed: Aug. 27, 2008
(86) PCT No.: PCT/JP2008/065253

§ 371 Date: Mar. 11, 2010

(30) Foreign Application Priority Data
Sep. 26, 2007 (JP) 2007-249201

(51) Int. Cl. C04B 35/64; C01B 13/14; C09K 5/00

(52) U.S. Cl. 264/681; 423/592.1; 252/71

(57) ABSTRACT

Disclosed is a highly functional low-cost metal complex oxide having low resistivity and excellent high-temperature stability, which places only little burden on the environment. Specifically, a metal complex oxide is produced by a method which is characterized by comprising a calcination step for obtaining a calcine containing a metal complex oxide, a cleaning step for cleaning the calcine with purified water, and a firing step for firing the cleaned calcine. Preferably, the calcine is cleaned with purified water a plurality of times for obtaining a sintered body having less structural defects. Since a perovskite oxide produced by this method has a low resistivity and a high output factor, it can be used as a thermoelectric material.

### TECHNICAL FIELD

The present invention relates to a method for producing a metal complex oxide sintered body that is useful as a thermoelectric conversion material or the like, and specifically relates to a method for producing a perovskite-type complex oxide sintered body containing a rare earth element, an alkali earth metal element, and manganese.

### BACKGROUND ART

A thermoelectric conversion element makes a π-type element from two types of thermoelectric semiconductors of p-type and n-type, and is configured by multiply connecting these in series. Semiconductors such as a Bi₂Te₃ system and a SiGe system have been preferably used as these thermoelectric semiconductors. However, the Bi₂Te₃ system and SiGe system have extremely high raw material cost, and are inferior in high temperature stability. In addition, due to containing toxic elements, universalizing and enlarging the thermoelectric conversion modules has been difficult in view of increasing the environmental burden and the like.

Contrary to this, thermoelectric conversion materials of ceramic oxide systems do not contain rare elements or environmentally unfriendly substances. In addition, they have characteristics in having high heat resistance, and in that deterioration of the thermoelectric property is small, even when used for long time periods at high temperature. As a result, they have been gaining attention as a material as an alternative to composite semiconductors. For example, a substance has been disclosed in which 10% of the Ca sites of a perovskite-type compound, represented by the general formula CaMnO₃, have been substituted with metallic elements such as Bi, La, and Ce (refer to Non-patent Document 1).

The thermoelectric conversion material of a ceramic-oxide system in Non-patent Document 1 has a remarkable increase in electrical conductivity due to substituting a portion of the Ca sites in CaMnO₃, which is an n-type semiconductor that exhibits high electrical resistance, with an element having high atomic valence. In addition, when Bi is used as a substituting element, a maximum output factor is obtained. However, since the Seebeck coefficient has a negative correlation with the carrier concentration, if the carrier concentration is increased, there is a problem in that the Seebeck coefficient is decreased, which limits the accessible performance index.

Consequently, a perovskite-type oxide containing cobalt has recently gained attention as a material that excels in high temperature stability and has little burden on the environment, compared to conventional materials. (refer to Patent Document 1)

Non-patent Document 1: Ohtaki, Michitaka et al.; Journal of Solid State Chemistry, 120, pp. 105-111 (1995)

Patent Document 1: Japanese Unexamined Patent Application Publication No. 2005-225735

### DISCLOSURE OF THE INVENTION

### Problems to be Solved by the Invention

However, since high-priced cobalt is contained as a main ingredient in the cobalt containing oxide of Patent Document 1, it is not adequate from the view point of universalizing and enlarging the thermoelectric modules. Although a new CaMnO₃-type thermoelectric material that has a high level of functionality at low cost has been considered as a material to solve these problems, a further improvement in thermoelectric characteristics is desired.

The present invention was made in order to solve the above such problems, and the object thereof is to provide a highly functional material that has low electrical resistance, at low cost, excels in high temperature stability, has little environmental burden, and the like.

### Means for Solving the Problems

The present inventors have focused on and thoroughly investigated reducing resistivity in order to improve the thermoelectric characteristics of a thermoelectric conversion element. As a result, they discovered that impurities inside the grain boundary invites deterioration in thermoelectric characteristics, and thus arrived at completing the present invention by removing, in a method for producing a metal complex oxide sintered body, unreacted substances by way of washing powder with purified water after preliminary calcination. More specifically, the present invention provides the following.

According to a first aspect, a method for producing a metal complex oxide sintered body, includes:

a preliminary calcination step of obtaining a preliminary calcine containing a metal complex oxide;

a washing step of washing the preliminary calcine with purified water; and

a main calcination step of mainly calcining the preliminary calcine having undergone the washing step.

According to the first aspect of the invention, since impurities inside the crystal grain boundary of the metal complex oxide sintered body can be removed by performing washing of a preliminary calcine with purified water, it is possible to produce a metal complex oxide sintered body that has further reduced electrical resistivity and more favorable thermoelectric characteristics than a metal complex oxide sintered body produced by a conventional production method.

According to a second aspect, the method for producing a metal complex oxide sintered body as described in the first aspect further includes, between the washing step and the main calcination step, a molding step of molding the preliminary calcine having undergone the washing step.

According to the second aspect of the invention, a metal complex oxide sintered body of a preferred size is obtained by providing a step of molding, and thus it can be used as a thermoelectric conversion element.

According to a third aspect, in the method for producing a metal complex oxide sintered body as described in the first or second aspect, the metal complex oxide sintered body is represented by a general formula Ca₍₁₋ₓ₎MₓMnO₃, in which M is at least one type of element selected from the group consisting of yttrium and lanthanoids, and x is in the range of 0.001 to 0.05.

According to the third aspect of the invention, a perovskite-type complex oxide that excels in heat resistance and has high functionality such as having a high output factor can be produced at low cost by the general formula ABO₃ of the perovskite-type complex oxide being set to the general formula Ca₍₁₋ₓ₎MₓMnO₃, in which M is at least one type of element selected from the group consisting of yttrium and lanthanoids, and x is in the range of 0.001 to 0.05.

According to a fourth aspect, the method for producing a metal complex oxide sintered body as described in any one of the first to third aspects, further includes, between the preliminary calcination step and the washing step, a wet-milling step of wet-milling the preliminary calcine.

According to the fourth aspect of the invention, by providing a wet-milling step between the preliminary calcination step and the washing step, a metal complex oxide sintered body with a further reduced electrical resistivity and additional output factor can be produced, since removal of unreacted substances becomes easy by finely grinding the preliminary calcine.

According to a fifth aspect, in the method for producing a metal complex oxide sintered body as described in any one of the first to fourth aspects, the preliminary calcine is washed a plurality of times with purified water in the washing step.

According to the fifth aspect of the invention, more unreacted substances can be removed by adding steps of washing, and a metal complex oxide sintered body with a reduced electrical resistivity and added output factor can be produced.

### EFFECTS OF THE INVENTION

According to the present invention, a metal complex oxide sintered body that has low electrical resistance, at low cost, excels in high temperature stability, and has little environmental burden can be produced by producing a metal complex oxide sintered body with a method characterized by including a preliminary calcination step of obtaining a preliminary calcine containing a metal complex oxide, and a washing step of washing the preliminary calcine with purified water.

### PREFERRED MODE FOR CARRYING OUT THE INVENTION

Although embodiments of a metal complex oxide sintered body of the present invention are described in detail below, the present invention is in no way limited to the following embodiments, and suitable modifications thereto can additionally be carried out within the scope of the object of the present invention. It should be noted that, for passages in which descriptions overlap, the description may be suitably omitted; however, this is not to limit the spirit of the present invention.

### Method for Producing Metal Complex Oxide Sintered Body

First, the raw materials are weighed and mixed. The raw materials are not particularly limited. For example, they may be exemplified by carbonates, nitrates, hydroxides, oxides, sulfates, oxalates, and halides containing a metallic element such as an alkali-earth metal, transition metal, and rare-earth element, and the like.

Although there are various techniques that can be used in mixing, for example, mixing with a mortar, mixing with a ball mill, mixing with a V-shaped mixer, mixing with a cross-rotary mixer, mixing with a jet mill, mixing with an agitator and the like, these mixing methods are well-known techniques. In addition, a dry-mixing process in which only raw materials are mixed entirely without using a solvent, or a wet-mixing process in which raw materials are dropped into a solvent such as water or an organic solvent, and this is mixed by dispersing in the solvent, or the like can be used as the mixing process. It should be noted that steps of filtering and drying the mixed raw materials become necessary in the case of carrying out a wet-mixing process that can be suitably employed in the present invention. The drying process is not particularly limited.

It should be noted that the raw material powder compound is preferably heat treated before weighing. The water component in the powder can be removed by heat treating, and thus it can be accurately weighed.

Next, the mixed powder thus obtained after mixing is preliminarily calcined. Since the preliminary calcine is more stable than the raw material oxide powder that constitutes the complex oxide, and thus reactivity is lowered by including a preliminary calcination step, abnormal grain growth and generation of a glass phase during the main calcination are suppressed, and thus the high-temperature strength characteristics of the material are further improved.

Calcining indicates causing a mixed substance to change into a different substance by reacting at high temperature. In addition, it is also a process that raises the density of a compact.

The heating apparatus used in calcining is not particularly limited so long as it achieves calcination of the mixed powder in a desired atmosphere at a desired temperature in a desired time period. For example, a heating apparatus such as an electric furnace or gas furnace can be employed. If giving an example of a case in which an electric furnace is employed as the heating apparatus, a tubular atmosphere furnace, an atmosphere controlled box-type furnace, a belt-conveyor furnace, a roller-hearth furnace, a continuous tray pusher furnace or the like can be employed. In addition, generally, a precursor powder is placed into a calcination container such as a crucible or boat, the calcination container is covered according to the situation, and is heated along with the calcination container; however, only the mixed raw material may be calcined without using the calcination container. It should be noted that a container composed of platinum, quartz, alumina, zirconia, magnesia, silicon carbide, silicon nitride, porcelain, carbon or the like can be used as the calcination container, and according to the situation, these can be compounded to use.

Although the calcination conditions of preliminary calcination are not particularly limited, the calcination temperature is preferably 900 to 1100° C., and more preferably 950 to 1050° C. This range of calcination temperature is preferred because when calcined at 900° C. or higher, the reaction is substantially completed, and is preferred when calcined at 1100° C. or less because over-sintering and abnormal grain growth can be suppressed.

The calcination time is preferably two to ten hours. More preferably, it is three to seven hours. When two or more hours, it is preferred because the reaction can substantially completed, and when ten or less hours, it is preferred because over-sintering and abnormal grain growth can be suppressed.

The preliminary calcination atmosphere is preferably an oxidizing atmosphere such as in an air or oxygen flow.

The number of times calcining is not particularly limited; however, a small number of times is preferred from the view point of raising production efficiency.

Next, the preliminary calcine is pulverized. By pulverizing, removing unreacted substances in a subsequent step is made easy.

In pulverization, the preliminary sintered body (aggregate of powder) obtained from the above-mentioned preliminary calcination is pulverized into particle form. It should be noted that a variety of techniques can be used in pulverization of the preliminary sintered body. As examples that can be given, there are granulating with a mortar, granulating with a ball mill, granulating using a V-shaped mixer, granulating using a cross-rotary mixer, granulating using a jet mill, and pulverizing with a crusher, motorized grinder, vibrating cup mill, disk mill, rotor-speed mill, cutting mill, hammer mill, media agitating mill, and the like. In addition, a dry-granulating process in which the calcine is granulated entirely without using a dispersion medium, or a wet-granulating process in which the calcine is put into a dispersion medium such as water or an organic solvent, and this is granulated in the dispersion medium, can be employed as a pulverizing process. In the present invention, the dispersion medium being purified water is preferred due to being able to remove unreacted substances.

Next, the preliminary calcine thus pulverized is washed with purified water. Since unreacted substances in the preliminary sintered body can be removed by washing with purified water, it is possible to produce a metal complex oxide sintered body that has further reduced electrical resistivity than a metal complex oxide sintered body produced by a conventional production method.

The purified water used in washing is a liquid containing purified water, and is not particularly limited so long as it can remove basic oxides, which are impurities, by washing.

The amount of preliminary sintered body, amount of purified water, and washing time used in washing are not particularly limited. Regarding the number of times washing, it is preferable to perform it a plurality of times since removal of impurities (basic oxides) separated at the grain boundary portion can be promoted. In confirming whether the impurities have been removed, in a case of the raw material or impurities being metal oxides, since these are basic oxides that react with water only to become a hydroxide having basicity, these can be confirmed by measuring the pH.

The preliminary calcined body pulverized product after washing is filtered and dried. The drying method is not particularly limited.

Next, the preliminary sintered body pulverized product thus dried after washing is granulated. Granulation, when handling the grains, refers to an operation for adjusting to a size and shape suited to a target use. Molding can be facilitated by granulation.

During granulation, a binder may be added. By adding a binder, the strength of the compact obtained after the molding step carried out subsequently can be maintained. Polyvinyl alcohol can be given as an example of the binder.

Next, the preliminary sintered body thus granulated is molded. By providing a step of molding a sintered powder, it becomes possible to use as a thermoelectric conversion element having preferable dimensions.

Although the molding can employ methods such as press molding, plastic shaping, cast molding, and doctor-blade molding, it is preferably press molding. It should be noted that the pressure when carrying out press molding is preferably 0.5 to 2 t/cm², and is more preferably 0.8 to 1.2 t/cm² (1 kgf/cm²=9.80665×10⁴(Pa)). In addition, the molding process may be either a dry-molding process or wet-molding process.

It may further include steps of drying, cutting, machining, and degreasing the compact obtained by molding, or the like.

Next is a step of mainly calcining the preliminary calcine thus molded. A metal complex oxide sintered body can be obtained from the main calcination.

Although the calcination conditions in the main calcination are not particularly limited, the calcination temperature is preferably 1100 to 1300° C., and more preferably 1150 to 1250° C. This calcination temperature range is preferred because when calcining at 1100° C. or higher, densification of the sintered body occurs, and is preferred because when calcining at 1300° C. or lower, the occurrence of cracks accompanying densification is suppressed.

The calcination time is preferably two to ten hours. It is more preferably four to seven hours. This is preferred because, when it is at least two hours, densification occurs, and this is preferred because when it is no more than ten hours, the occurrence of cracks accompanying densification is suppressed.

Although the calcination atmosphere is not particularly limited, it is preferably an oxidizing atmosphere such as in an air or an oxygen flow.

The number of times calcining is not particularly limited, so long as a desired crystal can be obtained, and is preferably a small number of times from the view point of raising production efficiency.

It should noted that, so long as including a step of washing the preliminary calcine with purified water, the way of combining, the order, and the number of times of each of the above steps is not particularly limited, and can be suitably set according to a variety of metal complex oxide sintered bodies and a target.

### Metal Complex Oxide Sintered Body

The metal complex oxide produced according to the present invention can be exemplified by an oxide represented by the general formula Ca₍₁₋ₓ₎MₓMnO₃, in which M is at least one type of element selected from yttrium and lanthanoids, and x is in the range of 0.001 to 0.05. Since a carrier can be introduced by adding these elements, it is possible to greatly improve electrical conductivity. x represents a substitution rate when substituting Ca with a trace element. Although the optimum substitution amount differs according to the application, when using as a thermoelectric conversion material, for example, x is preferably 0.001 to 0.05, and more preferably 0.01 to 0.03. The substitution rate being at least 0.001 is preferred because the electrical conductivity becomes at least 10 (S/cm), and being no more than 0.05 is preferred because the absolute value of the Seebeck coefficient becomes at least 150 μV/K.

### Application

For example, Ca₍₁₋ₓ₎MₓMnO₃, which is the metal complex oxide sintered body produced by the present invention, in which M is at least one type of element selected from yttrium and lanthanoids, and x is in the range of 0.001 to 0.05, can be employed as a thermoelectric conversion material.

Thermoelectric conversion refers to applying the Seebeck effect and Peltier effect, and mutually converting thermal energy to electrical energy. When using thermoelectric conversion, it is possible to extract electric power from heat flow using the Seebeck effect, and to bring about an endothermic cooling phenomenon by flowing electric current using the Peltier effect. In a thermoelectric conversion element, a single element composed of metal and semiconductor is generally employed, and the performance index thereof depends on the high-order structure (degree of crystallinity, etc.) of the compound of the thermoelectric conversion material. As a result, it is necessary to make a compound having few structural defects the thermoelectric conversion material in order to obtain a single element with a high performance index. The metal complex oxide produced by the present invention is a compound having few structural defects due to being a metal complex oxide sintered body in which impurities and the like, which separate to the grain boundary portion of the crystal, have been removed. Therefore, it can be used as a thermoelectric conversion material.

The metal complex oxide produced by the present invention is a compound possessing electrical conductivity, and can also be used as an electrically-conductive material. For example, it can be used in electrodes.

### EXAMPLES

### Example 1

0.244 mol of calcium carbonate, 0.25 mol of manganese carbonate and 0.003 mol of yttrium oxide were dispersed in 150 ml of purified water inside a mixing pot in which pulverizing balls had been placed, and the contents of the mixing pot were mixed by mounting this mixing pot to a vibrating ball mill, and causing to vibrate for two hours. Next, the mixture thus obtained was filtered and dried, and then the mixture after drying was preliminarily calcined in an electric furnace at 1000° C. for five hours. Next, after wet-milling the preliminary calcined body thus obtained by the vibrating mill, a preliminary calcined ground product was obtained by filtering and drying. Ten grams of this preliminary calcined ground product was washed by agitating in 200 ml of purified water for one hour. After carrying out this washing operation three times, it was filtered and dried. Next, a binder was added to the ground product after drying, and granulated. Thereafter, the granulated bodies thus obtained were molded with a press machine, and the compact thus obtained was subject to main calcination at 1200° C. for five hours. Thus, a sintered body was obtained.

### Example 2

A sintered body was produced by a similar method to Example 1 except for carrying out “the washing operation five times” instead of carrying out “the washing operation three times”.

### Example 3

A sintered body was produced by a similar method to Example 1 except for carrying out “the washing operation ten times” instead of carrying out “the washing operation three times”.

### Comparative Example 1

A sintered body was produced by a similar method to Example 1, except the step of washing three times with purified water was excluded.

### Evaluation of pH

In the evaluation of pH for the examples, pH of preliminary calcine filtered liquid after completing washing was measured with a pH litmus paper. For the comparative example, the pH of the calcine after the wet-milling process was measured. The measurement results are shown in Table 1.

### Measurement of Thermoelectric Characteristics

Electrodes were formed by applying silver paste to both ends of the sintered body thus obtained and baking, and measurement of the Seebeck coefficient and resistivity was carried out. It should be noted that, given the temperature differential at the top and bottom faces of the thermoelectric conversion element, and measuring the electrical potential over both ends of a sample, the Seebeck coefficient was calculated using the follow formula.

S=dV/dT (S=Seebeck coefficient, dV=electric potential between two points, dT=temperature differential between two points)

In addition, resistance was measured using a four-terminal method. The four-terminal method indicates a method of calculating resistance by measuring the electrical potential generated when two electrode terminals, a total of four, are attached to both ends of a measurement sample, and a constant current flows therethrough. The results thereof are shown in Table 1.

TABLE 1

| | | | SEEBECK | |
|---|---|---|---|---|
| NUMBER OF | pH of | RESIS- | COEFFI- | OUTPUT |
| TIMES | filtered | TIVITY | CIENT | FACTOR |
| WASHING | liquid | (Ω · cm) | (μV/K) | 10⁻⁴ W/(M · k²) |
| EXAMPLE 1 | 9 | 0.0065 | 177 | 4.81 |
| EXAMPLE 2 | 8 | 0.0061 | 175 | 5.02 |
| EXAMPLE 3 | 7 | 0.0059 | 174 | 5.13 |
| COMPARATIVE | 11 | 0.0072 | 179 | 4.45 |
| EXAMPLE 1 | | | | |

As is evident from Table 1, it has been confirmed that the output factor is improved by removing impurities having basicity by way of washing with purified water after wet milling of the preliminary calcine.

1. A method for producing a metal complex oxide sintered body, comprising:
obtaining a preliminary calcine containing a metal complex oxide;
washing the preliminary calcine with purified water; and
calcining the preliminary calcine having undergone the washing step.

2. The method for producing a metal complex oxide sintered body according to claim 1, further comprising, between the washing step and the final calcination step, a molding step of molding the preliminary calcine having undergone the washing step.

3. The method for producing a metal complex oxide sintered body according to claim 1, wherein the metal complex oxide sintered body is represented by a general formula Ca₍₁₋ₓ₎MₓMnO₃, wherein M is at least one type of element selected from the group consisting of yttrium and lanthanoid, and x is in the range of 0.001 to 0.05.

4. The method for producing a metal complex oxide sintered body according to claim 1, further comprising, between the preliminary calcination step and the washing step, a wet-milling of the preliminary calcine.

5. The method for producing a metal complex oxide sintered body according to claim 1, wherein the preliminary calcine is washed a plurality of times with purified water in the washing step.

6. The method for producing a metal complex oxide sintered body according to claim 2, wherein the metal complex oxide sintered body is represented by a general formula Ca₍₁₋ₓ₎MₓMnO₃, wherein M is at least one type of element selected from the group consisting of yttrium and lanthanoid, and x is in the range of 0.001 to 0.05.

7. The method for producing a metal complex oxide sintered body according to claim 2, further comprising, between the preliminary calcination step and the washing step, a wet-milling of the preliminary calcine.

8. The method for producing a metal complex oxide sintered body according to claim 3, further comprising, between the preliminary calcination step and the washing step, a wet-milling of the preliminary calcine.

9. The method for producing a metal complex oxide sintered body according to claim 2, wherein the preliminary calcine is washed a plurality of times with purified water in the washing step.

10. The method for producing a metal complex oxide sintered body according to claim 3, wherein the preliminary calcine is washed a plurality of times with purified water in the washing step.

11. The method for producing a metal complex oxide sintered body according to claim 4, wherein the preliminary calcine is washed a plurality of times with purified water in the washing step.
